(19) United States
(12) Patent Application Publication
(10) Pub. No.: US 2024/0028670 A1
(43) Pub. Date: Jan. 25, 2024

(54) MULTIMEDIA TRAFFIC CLASSIFICATION METHOD USING MARKOV COMPONENTS AND SYSTEM IMPLEMENTING THE SAME

(71) Applicants: SABANCI UNIVERSITY, Istanbul (TR); AIRTIES KABLOSUZ ILETISIM SAN VE DIS TIC ANONIM SIRKETI, Istanbul (TR)

(72) Inventors: Huseyin OZKAN, Istanbul (TR); Recep TEMELLI, Istanbul (TR); Ozgur GURBUZ, Istanbul (TR); Oguz Kagan KOKSAL, Istanbul (TR); Ahmet Kaan IPEKOREN, Istanbul (TR); Furkan CANBAL, Istanbul (TR); Baran Deniz KARAHAN, Istanbul (TR); Mehmet Sukru KURAN, Istanbul (TR)

(73) Assignees: SABANCI UNIVERSITY, Istanbul (TR); AIRTIES KABLOSUZ ILETISIM SAN VE DIS TIC ANONIM SIRKETI, Istanbul (TR)

(21) Appl. No.: 17/864,444

(22) Filed: Jul. 14, 2022

(51) Int. Cl. G06K 9/62; H04L 43/12; H04L 47/2441

(52) U.S. Cl. CPC G06K 9/6297; G06K 9/6276; H04L 43/12; H04L 47/2441

(57) ABSTRACT

An application-based traffic classification method for ensuring quality-of-service requirements for at least one network comprises at least one preprocessing-related step, a data classification-related step, and a learning-related step; the preprocessing-related step includes at least a windowing and sampling substep, a sub step of generating a classification dataset with labels, and a sub step of Lloyd-Max quantization, whereby an input stream is modeled as a discrete time Markov chain; the learning-related step includes at least one substep of training at least one classifier selected from a group including a classifier for a mixture of Markov components, a classifier for a k-nearest Markov component, and a classifier for a k-nearest Markov parameter; the classification-related step comprises at least one instance of application identification whereby the type of the application is determined using the trained classifier in said learning-related step.

### TECHNICAL FIELD

The invention presented methods of data stream classification based on behavioral paradigms. Disclosed invention specifically relates to methods and systems used for assessing and ensuring improved network performance using certain metrics and machine learning.

### BACKGROUND

Internet comprises different types of multimedia traffic, a significant portion thereof belonging to video applications, such as video-on-demand and streaming video, each having its own characteristics and Quality of Service (QoS) requirements. In order to provide the best end-to-end (ETE) user experience, network protocols and components must work according to the type of traffic, while at the same time considering the characteristics and QoS requirements.

Although the traffic sources are well-aware of the type of traffic they generate, this information is often lost afterwards in the network due to the lack of support from the applications and policies of the autonomous systems forming Internet. Consequently, severe performance degradation occurs for especially traffic with stringent QoS requirements. Therefore, it is of paramount importance to be aware of the traffic type for any network component and at any time.

Traffic classification work known in the art typically employs one of the four approaches: handling of packet tags, mapping packet address information, deep packet inspection (DPI), and analyzing packet flows with various machine learning techniques. The ones of handling packet tags usually focus on the DiffSery Code Point (DSCP) tags within the IP packet headers. With the recent WebRTC protocol effort having been recently supported by the IETF, usage of DSCP tags has gained importance. In this method, the applications are expected to tag the packets at generation according to respective QoS classes.

Then, the network components utilize DSCP tags in their traffic prioritization decisions. For the specific case of the wireless last-hop with WiFi, the DSCP tags are mapped into the 802.11e ACs, however, DSCP tags are set in only a small portion (2-8.5%) of the overall Internet traffic. Studies show that often times, the DSCP tags are remarked and zeroed via the routers of the intermediate Autonomous Systems (ASs) along the path between the source and destination nodes. Therefore, usage of DSCP tags for a reliable method of traffic classification becomes very limited.

Machine learning based techniques, on the other hand, analyze traffic flows and generate various descriptive features like packet size, packet inter-arrival time, packet transmission, etc. Various classification schemes are then used with such features to recognize the traffic type. Video, audio and control flows composing a video streaming application are classified in Microsoft Office IP Address and URL web service, via support vector machines. Various background and multimedia applications are classified with k-nearest neighbor (kNN), J48, and random forests in “A survey on regular expression matching for deep packet inspection: Applications, algorithms, and hardware platforms” by Xu et al. A more recent work, by Azab et al. considers popular video streaming applications, namely Netflix and Youtube, employing aforementioned approaches.

EP 3275124 B1 proposes a method for video traffic behavioral classification using coarse and fine data of a given flow data. In this method, first the mechanism receives coarse flow data from a network router which includes summary statistics for data flows on the router. Then, the mechanism classifies the summary statistics to detect video flows from among the data flows. Next, the mechanism requests fine flow data from the network router for each of the detected video flows, where the fine flow data includes information on a per packet basis. Using this fine flow data from the network router, the mechanism finally classifies each of the detected video flows per video service provider in accordance with the information.

Maheshwari et al. in their study titled “A joint parametric prediction model for wireless internet traffic using Hidden Markov Model” disclose a measurement framework that is set-up to collect the QoS parameters and a traffic model is designed based on Hidden Markov Model (HMI) considering joint distribution of End to End Delay (E2ED), Inter-Packet Delay Variation (IPDV) and Packet Size. States are mapped to the four traffic classes, namely conversational, streaming, interactive, and background. The model was then validated by forecasting QoS parameters and the results were shown to be within the tolerance limit.

Shen et al. in their study titled “Classification of Encrypted Traffic With Second-Order Markov Chains and Application Attribute Bigrams” propose a method using bigrams specific to the applications to be monitored, to diversify the ways said applications may be identified. This uses second-order homogeneous Markov chains next to one such bigram consisting of certificate packet length and first application data size in SSL/TLS sessions.

US 2010250918 A1 discloses a system and method for identifying an application type from encrypted traffic transported over an IP network. It extracts at least a portion of IP flow parameters from the encrypted traffic using at least one of specific target encryption types. Said method and system transmit the extracted IP flow parameters to a learning-based classification engine. Said learning-based classification engine has been trained with unencrypted traffic. Then, said method and system infer at least one corresponding application type for the extracted parameters for IP flow.

US 2020328947 A1 teaches a traffic analysis apparatus. It includes a first means that estimates a state sequence from time-series data of communication traffic based on a hidden Markov model, and groups, into one group, a plurality of patterns with resembling state transitions in the state sequence to perform extraction of a state sequence, with taking the plurality of patterns grouped into one group as one state; and a second means that determines an application state corresponding to the time-series data based on the state sequence extracted by the first means and predetermined application characteristics.

### SUMMARY

Primary object of the disclosed invention is to present a method of online traffic classification, more specifically multimedia traffic classification.

Another object of the disclosed invention is to present a method of online multimedia traffic classification whereby a flow rate metric of said multimedia traffic is modeled as a discrete time Markov chain (DTMC).

Another object of the disclosed invention is to present a method of online multimedia traffic classification whereby classification schemes varying on a spectrum containing local as well as global variables are used for determining type of application.

Another object of the disclosed invention is to present a method of online multimedla traffic classification whereby computational efficiency as well as superior accuracy are offered together.

Present invention discloses a novel method of multimedia traffic classification study multimedia traffic classification into popular applications to assist the QoS support of networking technologies, including but not limited to, WiFi, and propose various data driven classification schemes by modeling the traffic flow as a discrete-time Markov chain. A first classifier has a global perspective of the traffic data via the likelihood as a mixture of Markov components (MMC). A second and a third classifier have local perspective based on k-nearest Markov components (kNMC) with the negative loglikelihood as a distance as well as k-nearest Markov parameters (kNMP) with the Euclidean distance.

Present invention discloses a way of modeling the traffic flow rate signal, a significant and seminal information metric, with a stochastic discrete-time Markov chain (DTMC), after a discretization step of Lloyd-Max quantization. Said aspect of the invention produces an observation/likelihood model as a mixture of Markov components, experimentally effective.

Present invention also discloses, building up on the introduced stochastic DTMC modeling of the traffic flow rate signal, novel classification types that respectively utilize local and global classifier approaches for types of applications such as video-on-demand and live streaming, as well as various depths of accuracy such as at the application level and the category level.

Present invention therefore offers superior accuracy for correctly addressing the problem of multimedia traffic classification using the DTMC approach, combined with different, novel Markovian classification schemes that greatly reduce computational complexity. As such, disclosed invention has negligible space requirements, offers utmost compliance with QoS-related accurate multimedia traffic classification into applications and their categories. A crucial aspect is that with the disclosed invention, the underlying MAC level mechanisms (e.g., IEEE 802.11e or IEEE 802.11ax for WiFi) can be facilitated to ensure the required QoS. The presented approach can be used for this purpose with great success in not only WiFi but also other wireless last hop alternatives, as well as wired networks.

### BRIEF DESCRIPTION OF THE DRAWINGS

Accompanying figures are given solely for the purpose of exemplifying a non-DPI-based method and system for multimedia traffic classification focusing of mixture of Markov components, whose advantages over prior art were outlined above and will be explained in brief hereinafter.

The figures are not meant to delimit the scope of protection as identified in the claims nor should they be referred to alone in an effort to interpret the scope identified in said claims without recourse to the technical disclosure in the description of the present invention.

FIG. 1 demonstrates a home networking scenario containing several devices using different types of multimedia applications according to an embodiment of the disclosed invention.

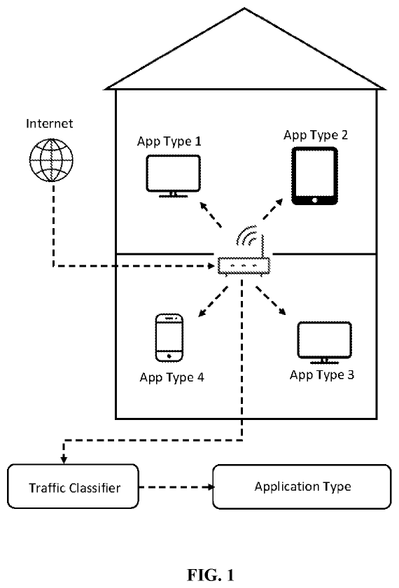

FIG. 2 demonstrates a flow diagram of the multimedia traffic classification method according to an embodiment of the disclosed invention.

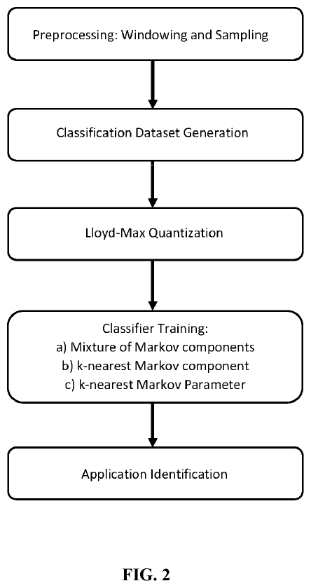

### DETAILED DESCRIPTION OF THE EMBODIMENTS

The present invention discloses a multiclass classification problem in the Bayesian multihypothesis detection framework and proposes a data driven solution based on a Markov modeling of the traffic source. To this end, the packet based traffic data is first converted to a flow based rate signal, which is processed by a sliding window to capture statistically stationary parts and classify timely. The windowed rate signal is quantized and modeled as a first order DTMC, providing an observation, i.e., instance, to the classification and the corresponding observation probability. Using a training set of labeled application instances each of which is also DTMC modeled, the posterior class conditional probability is estimated as a mixture of Markov components. Then, the maximum a posteriori decoder defines our first proposed classifier, named “mixture of Markov components classifier (MMC)”, which has a global perspective into the data since all the instances contribute to the classification.

Disclosed invention also proposes local classifiers that are based on the k-neighborhood of the test instance via two different metrics to determine the neighborhood. Using a likelihood based distance defines our second classifier, named “k-nearest Markov component classifier (kNMC)” and using Frobenius norm for comparing estimated parameter matrices defines our third classifier, named “k-nearest Markov parameter (kNMP)” classifier. Lastly, a two level application of the introduced kNMC (first at the category level then at the application level) provides an improved classifier which is called 2-level kNMC.

Disclosed invention further provides means to classify the traffic, i.e. detect the traffic type, as a selection of different applications. In one such embodiment, a selection of seven such applications may be as follows: Netflix, YouTube, YouTube Live, Twitch, Spotify, WhatsApp, Skype. Method disclosed in the invention accepts a stream of data, typically as a continuous-time signal u t of instantaneous rates for a duration of T seconds. Disclosed invention describes a supervised classification problem to learn a classifier using a training set of data with Nᵤ instances:

{u_{i,t}, l(u_{i,t})}ᵢ₌₁^{N}^{ᵤ}

where u_{i,t} and l(u_{i,t}) both pertain to the set of said seven applications that use traffic, each instance thereof representing the i'th observed traffic rate and the corresponding label. Also, any sample of u,,t is nonnegative and bounded with a finite real A and t is the time index vectorizing the rate samples into a column.

According to certain embodiments of the disclosed invention, streaming application might well be non-stationary, switching from one type, i.e. class, to another during the time course of observations. For this reason, method of the disclosed invention processes the data u_{i,t} by a sliding window approach, along with sampling with the sampling frequency (fs, Hz) as continuous precision having secondary importance. Sampling is with integration: a sampled value at a time is the result of integration as of the previous sample.

According to a feature in the disclosed invention, a pre-adjusted window length is utilized for sampling. Said predetermined window length Wₗ, is configured to be small in order to provide the twofold advantage of the windowed stream being better assumed to be from (or dominated by) a single application, and timeliness of said classification scheme in the disclosed invention improving, albeit perhaps at the cost of degrading classification accuracy. Disclosed method allows in cases where applications are switched thereamong, where a user does not stream from two or more applications at the same time; or where if they do, one of the streaming applications dominates the traffic. As such, disclosed method becomes successfully and greatly generalizable.

In the disclosed method, windowing and sampling result in the following form of the discrete-time dataset, whose size is now folded by T/Ws, as follows:

$${\\ \{ {x}_{i , n} , {y}_{i} ) \}}_{i = 1}^{{N}_{x}}$$

$$\\ where$$

$$\\ {N}_{x} = ⌊ \frac{T}{{W}_{s}} \times {N}_{u} ⌋ , {y}_{i} = {l}_{( {x}_{i , n} )}$$

each manually labelled, and Wₛ is the stride which is the amount of sliding of the window. Here, x_{i,n} (h) is used to refer to a specific sample at time 1≤h≤Wfₛ, of the i'th instance, and x_{i,n} is considered as the complete column vector of samples [x_{i,n}(1), x_{i,n}(2), . . . x_{i,n}(Wₗfₛ)]^{T}. Also, xn refers to any instance without a particular traffic type when the subscript i is dropped.

In the disclosed invention, the goal of traffic classification is formulated as hypothesis testing with:

Hⱼ:Xₙ˜Pₓ_{ₙ}_{Y|X}_{ₙ}(j|xₙ)

Here, P_{Xn|Y}(xₙ|j) is the conditional probability mass function for class-j traffic, as equal priors are assumed. Based on this formulation, a classifier is designed (delta), via a maximum a posteriori (MAP) decoding:

$$\\ δ ( {x}_{n} ) = arg {max}_{j} {P}_{Y \vert {X}_{n}} ( j \vert {x}_{n} ) = arg {max}_{j} \frac{{P}_{{X}_{n} \vert Y} ( {x}_{n} \vert j ) {π}_{j}}{{P}_{{X}_{n}} ( {x}_{n} )} = arg {max}_{j} {P}_{{X}_{n} \vert Y} ( {x}_{n} \vert j )$$

Disclosed invention, following from the previous steps, thus evaluates the problem to be an observation modeling P_{Xn}(xₙ) and estimating the likelihood P_{Xn|Y}(xₙ|j), both unknown. To this end, disclosed invention proposes a Markov model for characterizing the stochastic observation xn, and obtain model estimates using an introduced training set.

Disclosed invention takes advantage of a traffic flow rate observation modeling xn as a first order DTMC, with finite number Nₛ of states, where xₙ is a discrete-time continuous-amplitude signal. To generate the states of DTMC, disclosed method first partitions the amplitude range (or quantize) [0;A] into Nₛ amplitude states (or quantization levels), essentially obtaining the state sequence (or the digital signal) sₙ(h) that may be equal to any of said Nₛ amplitude states, for all h corresponding to a traffic observation xₙ. In the general case of Nₛ states, k-means algorithm is used. In an equivalent manner, the Lloyd-Max quantization may be utilized to cluster an entire set of amplitudes {x_{i,n}(h)}_{(i,h)=1,1}^{(N,W}^{ₗ}^{fs)} in the training set and obtain the quantization levels {lₖ}ₖ₌₁^{N}^{ₛ}.

Probability of the sequence xn could be represented as follows: To the extent that the probabilities of the state functions may be denoted by m=[m_{rq}]_{(r,q)=1,1}^{(N}^{ₛ}^{,N}^{ₛ}) with m_{rq} being the probability m_{rq}=P _{sn(h+1)|sn(h)}(q|r) of a transition from state r to state q. Consequently, probability of the sequence xₙ as Pₓ_{ₙ}(xₙ; m)

[symbol]

P_{S}_{ₙ}(sₙ; m)=Pₛ_{ₙ}₍₁₎(Sₙ(1))Πₕ₌₁^{w}^{ₗ}^{f}⁻¹mₛ_{ₙ}_{(h),s}_{ₙ}₍ₕ₊₁₎

Generality of the Wold decomposition allows Markov modeling of the sequence xₙ to not be restrictive. As such, no information is lost if the order and number of states (quantization levels) are chosen arbitrarily high. This means that DTMCs may be of different orders for different embodiments, and computational scalability would be a significant outcome.

According to an embodiment, said likelihood model _{Xn|Y}(xₙ|j) is represented as a mixture of Markov components. A sequence sₙ is essentially a quantized window from the original rate signal uₜ that one observes during a stream with seven possible aforementioned applications. This rate signal uₜ might well be nonstationary because of two reasons. First, the streamer can switch from one application to another, for which we have introduced windowing such that it is possible to capture a single streaming application within a window of a small period of time (recall that the streamer does not stream multiple applications simultaneously at a time, or if she/he does then we assume that one of the applications dominates). Second source of nonstationarity is that one can obtain different rate patterns even if the streaming application does not change. For example, a text-only messaging session between two persons does certainly create a different rate pattern compared to a mixed (text, voice and possibly image or video) session or a teleconferencing session may suddenly switch to a different pattern if the application degrades video quality to adjust according to the available bandwidth or the advertisements during a video on demand session can potentially affect the actual rate pattern with interrupts. This second issue can also be addressed with windowing such that a windowed rate signal is homogeneous, e.g., text-only or ad-free. Having observed this, windows coming from the same rate signal even under a single application now do not submit to a single Markov model, and thus a single Markov model becomes incapable of representing all windows. In order to address this in likelihood, disclosed invention clusters all available sequences xₙ's, and then estimates a Markov model per each cluster. Then what has to be determined is the right number of clusters, which is often difficult and ambiguous since it (determining the number of clusters) is often an ill-posed problem.

Disclosed invention also exploits the idea of non-parametric density estimation, where one considers a probability spread function (e.g., radial basis function) around each instance to distribute the point mass typically inversely with respect to the distance from that instance. Similarly, disclosed invention estimates the likelihood, i.e., the conditional probability mass, as a mixture of Markov components. Said mixture of Markov components is dense because disclosed invention proposes a specific Markov component for each training instance, meaning that having only a few as in the case of clustering is not necessary with the introduced method. As such,

$$\\ {P}_{{X}_{n} \vert Y} ( {x}_{n} \vert j ) {=}^{△} \frac{1}{{N}_{j}} {\sum }_{∀ i : {y}_{i} = j} {P}_{{X}_{n}} ( {x}_{n} ; {m}^{i} ) = \frac{1}{{N}_{j}} {\sum }_{∀ i : {y}_{i} = j} {\prod }_{h = 1}^{{W}_{l} {f}_{s} - 1} {m}_{{s}_{n} ( h ) , {s}_{n} ( h + 1 )}^{i}$$

where (a) 1_{{.}} is the indicator function returning 1 if its argument holds and 0 otherwise, (b) Nⱼ=Σᵢ₌₁^{N}^{ₓ}1_{{y}_{ᵢ}_{=j}} is the total number of class-j instances in the training set {x_{i,n}, yᵢ}ᵢ₌₁^{N}^{ₓ}, (c) m¹ is the probability matrix of state transitions estimated from the i'th training instance x_{i,n} and (d) the probability of the initial state observation P_{S}_{ₙ}₍₁₎ⁱ(sₙ(1)) is ignored for ease of exposition since its amount in the likelihood is negligible due to a typically large Wₗfₛ. Therefore, as in the nonparametric density estimation, each class-j instance in the training set contributes to the likelihood P_{Xn-|Y}(xₙ|j). This contribution, as desired, proportionally scales with respect to how close the pattern of xₙ is to the sub-class pattern represented by that class-j instance. The closeness here is considered in terms of how likely the sequence xₙ can be generated from the Markov model of that class-j instance, i.e. P_{Xn}(xₙ; mⁱ); and the resulting average yields the desired class likelihood P_{Xn|Y}(xₙ|j). An alternative perspective lies in the data generation process of each class. As a result of the introduced likelihood P_{Xn|Y}(xₙ|j), if one is to randomly generate a class-j instance, then first a class-j training instance is drawn, say x_{i,n} and yᵢ=j, with probability 1/Nⱼ and afterwards a random sequence is generated from the corresponding Markov model of mⁱ. Lastly, one can also regard the introduced likelihood, i.e., the class specific probability mass P_{Xn|Y}(xₙ|j), as a (dense) mixture of Nⱼ-many Markov components, each of which is obtained by Markov modeling of the corresponding training instance.

Disclosed invention further discloses an array of different classifiers based on the introduced observation model and likelihood P_{Xn|Y}(xₙ|j). One such classifier is the mixture of Markov components (MMC) classifier. Said classifier is motivated by a maximum a posteriori approach that follows from the equations previously explained:

$$\\ δ ( {x}_{n} ) = arg {max}_{j} {P}_{{X}_{n} \vert Y} ( {x}_{n} \vert j ) = arg {max}_{j} log ( {P}_{{X}_{n} \vert Y} ( {x}_{n} \vert j ) ) = arg {max}_{j} log ( \frac{1}{{N}_{j}} {\sum }_{∀ i : {y}_{i} = j} {\prod }_{h = 1}^{{W}_{l} {f}_{s} - 1} {m}_{{s}_{n} ( h ) , {s}_{n} ( h + 1 )}^{i} )$$

where the product operator multiplies many small numbers, which may eventually lead to numerical precision issues in practice. To avoid such issues, what is taken advantage of is as displayed below:

$$\\ log ( {P}_{{X}_{n} \vert Y} ( {x}_{n} \vert j ) ) = log ( \frac{1}{{N}_{j}} {\sum }_{∀ i : {y}_{i} = j} {\prod }_{h = 1}^{{W}_{l} {f}_{s} - 1} {m}_{{s}_{n} ( h ) , {s}_{n} ( h + 1 )}^{i} ) \geq \frac{1}{{N}_{j}} {\sum }_{∀ i : {y}_{i} = j} log ( {\prod }_{h = 1}^{{W}_{l} {f}_{s} - 1} {m}_{{s}_{n} ( h ) , {s}_{n} ( h + 1 )}^{i} ) = \frac{1}{{N}_{j}} {\sum }_{∀ i : {y}_{i} = j} {\sum }_{h = 1}^{{W}_{l} {f}_{s} - 1} log ( {m}_{{s}_{n} ( h ) , {s}_{n} ( h + 1 )}^{i} )$$

where the inequality follows by Jensen's inequality and provides a lower bound for the loglikelihood log(P_{Xn|Y}(xₙ|j)). As such, for practical value, instead of maximizing the likelihood, disclosed invention's method maximizes its lower-bound to define said first classifier as

$$\\ {δ}_{1} ( {x}_{n} ) {=}^{△} arg {max}_{j} \frac{1}{{N}_{j}} {\sum }_{∀ i : {y}_{i} = j} {\sum }_{h = 1}^{{W}_{l} {f}_{s} - 1} log ( {m}_{{s}_{n} ( h ) , {s}_{n} ( h + 1 )}^{i} )$$

which can be computed computationally highly efficiently in the run time in a recursive manner, courtesy of the straightforward recursive Markocv parameter estimations.

Disclosed invention also provides another classification scheme, namely the k-nearest Markov component (KNMC) classifier. It is observed that, aforementioned MMC classifier computes, in a sense, average negative likelihood distance between the test instance xₙ and each of the classes, and then chooses as its decision the class that minimizes the computed average distance. Namely, regarding dₗ(xₙ, x_{i,n}) [symbol] log (Pₓ_{ₙ}(xₙ, mⁱ)) as a likelihood-based distance (i.e. a distance in a nonrigorous vaguely defined manner without satisfying the metric properties) between the test instance xₙ and a training instance x_{i;n}, disclosed MMC classifier;

$$\\ {δ}_{1} ( {x}_{n} ) = arg {min}_{j} \frac{1}{{N}_{j}} {\sum }_{∀ i : {y}_{i} = j} {d}_{l} ( {x}_{n} , {x}_{i , n} )$$

minimizes the average of distances to class instances with respect to the class label j to make a decision.

It is observed that since all of the training instances contribute to the classification of xₙ in the above rule, the MMC classifier has indeed a global perspective into the data. This might be associated with a potential drawback, as instances that are far from xₙ (instances that are consequently putting large distances into the average) should eventually dominate as the data size increases and Nⱼ approaches infinity, especially when xₙ happens to lie in a locally sparse region. This would pull the average distances to each class to more or less a similar level and in turn decrease the power of differentiation. If disclosed Markov assumption happens to be perfect, then no detrimental effect should be expected since the problem is formulated in a Bayesian optimal manner (under Markov assumption). Nevertheless, if disclosed Markov assumption turns out not to be perfect, then one needs to take into account possible imperfections with the following.

The remedy for this, yielding with the second disclosed classifier in the invention, is to suppress the contributions from far instances and concentrate on a local region around the test instance xn without a global perspective as in the first MMC classifier δ₁(·), by only taking into account k instances (i.e., neighbors of xₙ) falling in that local region. We stress that once we get the k-nearest neighbors to the test instance xₙ, we drop weighting with respect to the distance as all instances we consider are now already in a small neighborhood and close to each other and thus small variations in that closeness can be noise and should not contribute. Based on this approach, we propose our second k-nearest Markov component (kNMC) classifier as a majority voter as

δ₂(·) [symbol] majority({y_{z(1)}, y_{z(2)}, . . , y_{z(k)}})

where z is a vector of indices such that {dₗ(xₙ, x_{z(i),n})}ᵢ₌₁^{N}^{ₓ} is sorted in ascending order, a random pick can be made in the case of ties among the tied options (or perhaps one can rely on the first classifier decision again among the tied options only), and k is the number of nearest neighbors and cross validated.

Dislosed invention proposes a third classifier by comparing Markov transition probabilities. Let m and m₁ denote the matrices of estimated transition probabilities for the Markov models of the test instance xₙ and a training instance x_{1;n}, then we define dₘ(xₙ, x_{i,n}) [symbol] |m−mⁱ|F to compare the two sets of parameters, where |·|F is the Frobenius norm. In a similar fashion to the kNMC classifier δ₂(·), our third k-nearest Markov parameter (kNMP) classifier δ₃(·) is presented as

δ₃(·) [symbol] majority({y_{z(1),} y_{z(2)}, . . . , y_{z(k)}})

Where z is a vector of indices such that {dₗ(xₙ, x_{z(i),n}}ᵢ₌₁^{N}^{ₓ} is in ascending order, a tie can be addressed by a random pick and k is optimized. We emphasize that our aim in presenting this relatively straightforward third classifier is to evaluate the efficacy of the distance of negative loglikelihood in contrast to Forbenius norm, i.e., kNMC δ₂(·) vs kNMP δ₃(·).

According to an embodiment of the present invention, an application-based traffic classification method for ensuring quality-of-service requirements for at least one network, comprising at least one preprocessing-related step, one data classification-related step, one learning-related step is proposed.

According to at least one aspect of the disclosed invention, said preprocessing-related step includes at least one windowing and sampling substep, one substep of generating a classification dataset with labels, and a substep of discretization; whereby an input stream is modeled as a discrete time Markov chain.

According to at least one aspect of the disclosed invention, said learning-related step includes at least one substep of training at least one classifier selected from a group including a classifier for mixture of Markov components; a classifier for k-nearest Markov component; a classifier for k-nearest Markov parameter.

According to at least one aspect of the disclosed invention, said classification-related step comprises at least one instance of application identification whereby the type of the application is determined using the trained classifier in said learning-related step. According to at least one aspect of the disclosed invention, Lloyd-Max quantization is implemented in said sub step of discretization.

According to at least one embodiment in the disclosed invention, a multimedia traffic apparatus comprising at least a processing means, a storage means, a network probing means is proposed.

According to at least one aspect of the disclosed invention, said processing means is configured to perform at least one preprocessing-related step, one data classification-related step, and one learning-related step.

According to at least one aspect of the disclosed invention, said processing means is configured to perform at least one windowing and sampling substep, one substep of generating a classification dataset with labels, and a substep of discretization; whereby an input stream is modeled as a discrete time Markov chain.

According to at least one aspect of the disclosed invention, said processing means is configured to perform at least one substep of training at least one classifier selected from a group including a classifier for mixture of Markov components; a classifier for k-nearest Markov component; a classifier for k-nearest Markov parameter.

According to at least one aspect of the disclosed invention, said processing means is configured to perform a classification-related step comprising at least one instance of application identification whereby the type of the application is determined using the trained classifier in said learning-related step.

According to at least one aspect of the disclosed invention, said processing means is configured to perform Lloyd-Max quantization as part of said substep of discretization.

According to at least one aspect of the disclosed invention, said network probing means is configured to receive network traffic information in a sequential manner.

According to at least one aspect of the disclosed invention, said storage means is configured to store at least one instance of a classifier for mixture of Markov components; a classifier for k-nearest Markov component; a classifier for k-nearest Markov parameter.

According to at least one aspect of the disclosed invention, said processing means is configured to select an appropriate classifier from the available classifiers based on a network health information provided by said network probing means.

1. An application-based traffic classification method for ensuring quality-of-service requirements for at least one network, comprising:
at least a preprocessing-related step, a data classification-related step, and a learning-related step;
wherein the preprocessing-related step includes at least a windowing and sampling substep, a substep of generating a classification dataset with labels, and a substep of discretization; wherein an input stream of the at least one network is modeled as a discrete time Markov chain, and
wherein the learning-related step includes at least a substep of training at least one classifier selected from a group including a classifier for a mixture of Markov components, a classifier for a k-nearest Markov component, and a classifier for a k-nearest Markov parameter.

2. The application-based traffic classification method according to claim 1, wherein the classification-related step comprises at least one instance of application identification wherein a type of an application is determined using a trained classifier in the learning-related step.

3. The application-based traffic classification method according to claims 1, wherein a Lloyd-Max quantization is implemented in the sub step of discretization.

4. The application-based traffic classification method according to claims 2, wherein a Lloyd-Max quantization is implemented in the sub step of discretization.

5. A multimedia traffic apparatus comprises a processing device, a storage device, and a network probing device, wherein the processing device is configured to perform the application-based traffic classification method according to claim 1.

6. The multimedia traffic apparatus according to claim 5, wherein the classification-related step comprises at least one instance of application identification wherein a type of an application is determined using a trained classifier in the learning-related step.

7. The multimedia traffic apparatus according to claims 5, wherein a Lloyd-Max quantization is implemented in the sub step of discretization.

8. The multimedia traffic apparatus according to claim 5, wherein the network probing device is configured to receive network traffic information in a sequential manner.

9. The multimedia traffic apparatus according to claims 5, wherein the storage device is configured to store at least one instance of a classifier for a mixture of Markov components, a classifier for a k-nearest Markov component, and a classifier for a k-nearest Markov parameter.

10. The multimedia traffic apparatus according to claims 8, wherein the storage device is configured to store at least one instance of a classifier for a mixture of Markov components, a classifier for a k-nearest Markov component, and a classifier for a k-nearest Markov parameter.

11. The multimedia traffic apparatus according to claims 5, wherein the processing device is configured to select an appropriate classifier from available classifiers based on network health information provided by the network probing device.

12. The multimedia traffic apparatus according to claims 8, wherein the processing device is configured to select an appropriate classifier from available classifiers based on network health information provided by the network probing device.

13. The multimedia traffic apparatus according to claims 9, wherein the processing device is configured to select an appropriate classifier from available classifiers based on network health information provided by the network probing device.

14. The multimedia traffic apparatus according to claims 10, wherein the processing device is configured to select an appropriate classifier from available classifiers based on network health information provided by the network probing device.
